(19) United States
(12) Patent Application Publication
(10) Pub. No.: US 2009/0128661 A1
(43) Pub. Date: May 21, 2009

(54) SYSTEM AND METHOD FOR SORTING IMAGES IN A MOBILE ELECTRONIC DEVICE

(75) Inventor: LUN-YI KUO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/262,185

(22) Filed: Oct. 31, 2008

(30) Foreign Application Priority Data
Nov. 16, 2007 (CN) 200710202569.6

(51) Int. Cl. H04N 5/76

(52) U.S. Cl. 348/231.2; 348/E05.024

(57) ABSTRACT

A method for sorting images in a mobile electronic device is provided. The method includes acquiring a longitude and a latitude of the mobile electronic device determined by a Global Position System (GPS) when an image has been captured by a camera of the mobile electronic device. The method further includes sorting all captured images according to a predetermined sorting distance, and generating one or more albums containing a group of captured images. Furthermore, the method includes computing an average longitude and an average latitude of the mobile electronic device for all sorted images in each album, and associating each album with the electronic map according to the average longitude and the average latitude of the mobile electronic device for all images in each album. A related system is also provided.

### BACKGROUND

1. Field of the Invention

Embodiments of the present disclosure are related to information management systems and methods, and particularly to a system and method for sorting images in a mobile electronic device.

2. Description of related art

A mobile electronic device is a pocket-sized computing device, which includes a small visual display for output and a miniature keyboard or touch screen for input. The mobile electronic device may be a mobile phone, a personal digital assistant (PDA), a handheld game player, a digital camera, or a Palm computer. Currently, the mobile electronic device has many auxiliary functions, such as a function for capturing images.

Usually, when using a camera to capture a number of images, users may manually sort the images. For example, the images captured in Hong Kong are sorted into a cluster, and the images captured in Beijing are sorted into another cluster. However, it may be not accurate for the users to sort the captured images manually if a user forgets where the images are captured. For example, if the user forgets that an image is captured in Hong Kong, the image may be sorted into a cluster in which the images are captured in Beijing.

### SUMMARY

A method for sorting images in a mobile electronic device is provided. The method includes acquiring a longitude and a latitude of the mobile electronic device determined by a Global Position System (GPS) when an image is captured by a camera, and associating the image with the longitude and the latitude of the mobile electronic device when capturing the image. The method further includes setting a sorting distance for sorting all images captured by the camera of the mobile electronic device, and sorting all captured images according to the sorting distance, subsequently generating one or more albums containing a group of captured images. Furthermore, the method includes computing an average longitude and an average latitude of the camera for all sorted images in each album, and associating each album with the electronic map according to the average longitude and the average latitude of the camera for all sorted images in each album.

Other objects, advantages and novel features will become more apparent from the following detailed description of certain embodiments of the present disclosure when taken in conjunction with the accompanying drawings.

### BRIEF DESCRIPTION OF THE DRAWINGS

FIG. 1 is a block diagram of one embodiment of a system for sorting images in a mobile electronic device.

FIG. 2 is a flowchart of one embodiment of a method for sorting images in a mobile electronic device of the present disclosure.

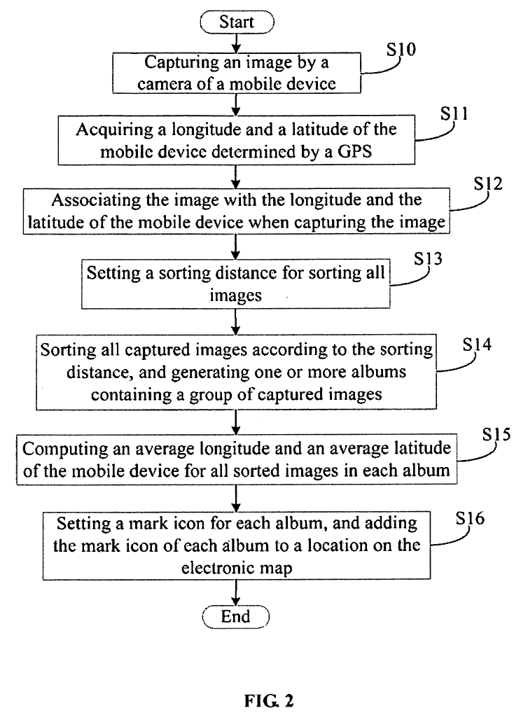

### DETAILED DESCRIPTION OF CERTAIN INVENTIVE EMBODIMENTS

All of the processes described below may be embodied in, and fully automated via, function modules executed by one or more general purpose processors of a mobile electronic device. Some or all of the methods may alternatively be embodied in specialized hardware.

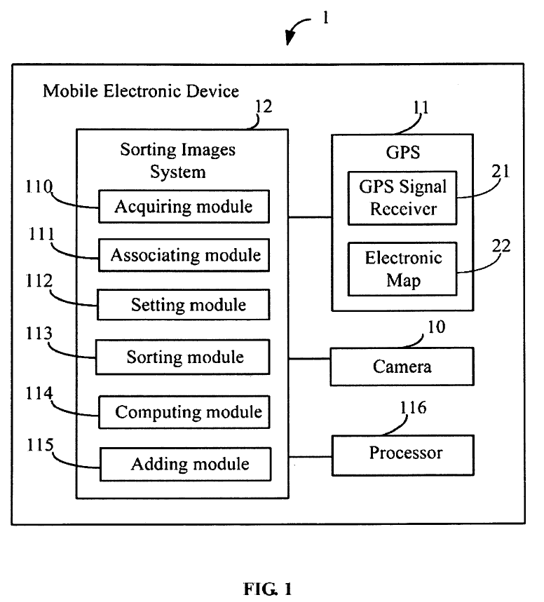

FIG. 1 is a block diagram of one embodiment of a system 12 for sorting images in a mobile electronic device 1. In one embodiment, the sorting images system 12 is installed and runs in a mobile electronic device 1. The mobile electronic device includes a Global Position System (GPS) 11 and a camera 10. Depending on the embodiment, the mobile electronic device 1 may be a mobile phone, a personal digital assistant (PDA), a handheld game player, a digital camera, or a Palm computer, among other portable electronic devices with an image capturing function.

The GPS 11 includes a GPS signal receiver 21 and an electronic map 22. The GPS signal receiver 21 is configured for receiving GPS signals from one or more satellites, and determining a longitude and a latitude of the mobile electronic device 1 when an image has been captured by the camera 10.

In one embodiment, the sorting images system 11 includes an acquiring module 110, an associating module 111, a setting module 112, a sorting module 113, a computing module 114, and an adding module 115. The modules 110, 111, 112, 113, 114, 115 may be used to execute one or more operations for the mobile electronic device 1. Additionally, the mobile electronic device 1 may comprise one or more specialized or general purpose processors, such as a processor 116, for executing the modules 110, 111, 112, 113, 114, 115.

The acquiring module 110 is configured for acquiring a longitude and latitude of the mobile electronic device 1 determined by the GPS 11 when an image is captured by the camera 10. In one embodiment, the GPS 11 determines a longitude and a latitude from the GPS signals from one or more satellites when the image has been captured. The acquiring module 110 acquires the longitude and the latitude from the GPS 11. For example, if the image is captured in Hong Kong, and the longitude and the longitude of the mobile electronic device 1 when capturing the image is (114°6′E, 22°12′N), then the acquiring module 110 acquires the longitude and the latitude (114°6′E, 22°12′N) from the GPS 11.

The associating module 111 is configured for associating the image with the longitude and the latitude of the mobile electronic device 1 when capturing the image.

The setting module 112 is configured for setting a sorting distance for sorting all captured images. The sorting distance is a distance between a first longitude and a first latitude of the mobile electronic device 1 when capturing a first image and a second longitude and a second latitude of the mobile electronic device 1 when capturing a second image. In one embodiment, the sorting distance may be measured in kilometers, for example.

The sorting module 113 is configured for sorting all captured images according to the sorting distance, and generating one or more albums containing a group of captured images. In each of the one or more albums, a real distance between two places for capturing any two images is less than or equal to the sorting distance of the images (hereinafter for simplification, “the real distance of two images”). For example, if an album contains three images A, B and C, and the sorting distance is 2 kilometers, then the real distance between A and B, A and C, B and C is less than or equal to 2 kilometers. In one embodiment, the real distance is computed according to the longitudes and the latitudes of the mobile electronic device 1 when capturing the two images. For example, if the longitude and latitude of the mobile electronic device 1 when capturing a first image is (114°6′E, 22°12′N), and the longitude and the latitude of the mobile electronic device 1 when capturing a second image is (114°4′E, 22°37′N), then the real distance is 46.51 kilometers.

The computing module 114 is configured for computing an average longitude and an average latitude of the mobile electronic device 1 for all sorted images in each album, and associating each album with the electronic map 22 according to the average longitude and the average latitude of the mobile electronic device 1 for all sorted images in each album. For example, if a album contain three images A, B, and C, the longitude and the latitude of the mobile electronic device 1 when capturing A is (80°E, 8°N), the longitude and the latitude of the mobile electronic device 1 when capturing B is (79°E, 9°N), and the longitude and the latitude of the mobile electronic device 1 when capturing C is (84°E, 7°N), then the average longitude and the average latitude of the mobile electronic device 1 for images in the album is (81°E, 8°N).

The mark adding module 116 is configured for setting a mark icon for each album, and adding the mark icon of each album to a location on the electronic map 22 according to the average longitude and the average latitude of the mobile electronic device 1 for images in each album. The mark icon on the electronic map 22 indicates location where the mobile electronic device 1 captured images. For example, assuming an album contains three captured images captured in Hong Kong, then a mark icon of Hong Kong is added to the electronic map 22.

FIG. 3 is a flowchart of one embodiment of a method for sorting images in a mobile electronic device 1 of the present disclosure. Depending on the embodiment, additional blocks may be added, while others deleted, and the blocks may also be executed in a different order than described.

In block S10, the camera 10 captures an image, and stores the image into a storage device of the mobile electronic device 1.

In block S11, the acquiring module 110 acquires a longitude and a latitude of the mobile electronic device 1 from a GPS 11.

In block S12, the associating module 111 associates the image with the longitude and the latitude of the mobile electronic device 1 when capturing the image.

In block S13, the setting module 112 sets a sorting distance for sorting all captured images. As mentioned above, the sorting distance is a distance between a first longitude and a first latitude of the mobile electronic device 1 when capturing a first image and a second longitude and a second latitude of the mobile electronic device 1 when capturing a second image.

In block S14, the sorting module 113 sorts all captured images according to the sorting distance, and generating one or more albums containing a group of captured images. In each of the one or more albums, a real distance between two places for capturing any two images is less than or equal to the sorting distance.

In block S15, the computing module 115 computes an average longitude and an average latitude of the mobile electronic device 1 for all sorted images in each album, and associating each album with the electronic map 22 according to the average longitude and the average latitude of the mobile electronic device 1 for all sorted images in each album.

In block S16, the mark adding module 116 sets a mark icon for each album, and adds the mark icon for each album to a location on the electronic map 22 according to the average longitude and the average latitude of the mobile electronic device 1 for images in each album.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for sorting images in a mobile electronic device, the system comprising:
an acquiring module configured for acquiring a longitude and a latitude of the mobile electronic device determined by a Global Position System (GPS) when an image has been captured by a camera of the mobile electronic device;
an associating module configured for associating the image with the longitude and the latitude of the mobile electronic device when capturing the image;
a setting module configured for setting a sorting distance for sorting all images captured by the camera of the mobile electronic device, wherein the sorting distance is a distance between a first longitude and a first latitude of the mobile electronic device when capturing a first image and a second longitude and a second latitude of the mobile electronic device when capturing a second image;
a sorting module configured for sorting all captured images according to the sorting distance, and generating one or more albums containing a group of captured images;
a computing module configured for computing an average longitude and an average latitude of the mobile electronic device for all sorted images in each album, and associating each album with the electronic map according to the average longitude and the average latitude of the mobile electronic device for all images in each album; and
at least one processor executing the associating module, the setting module, the sorting module and the computing module.

2. The system of claim 1, wherein the mobile electronic device is selected from the group consisting of a mobile phone, a personal digital assistant (PDA), a handheld game player, a digital camera, and a Palm computer.

3. The system of claim 1, the system further comprising a mark adding module configured for setting a mark icon for each album, and adding the mark icon of each album to a location on the electronic map according to the average longitude and the latitude of the camera for images in each album.

4. A method for sorting images in a mobile electronic device, the method comprising:
acquiring a longitude and a latitude of the mobile electronic device determined by a Global Position System (GPS) when an image has been captured by a camera of the mobile electronic device;
associating the image with the longitude and the latitude of the mobile electronic device when capturing the image;
setting a sorting distance for sorting all images captured by the camera of the mobile electronic device, wherein the sorting distance is a distance between a first longitude and a first latitude of the mobile electronic device when capturing a first image and a second longitude and a second latitude of the mobile electronic device when capturing a second image;
sorting all captured images according to the sorting distance, and generating one or more albums containing a group of captured images; and
computing an average longitude and an average latitude of the mobile electronic device for all sorted images in each album, and associating each album with the electronic map according to the average longitude and the average latitude of the mobile electronic device for all images in each album.

5. The method of claim 4, wherein the mobile electronic device is selected from the group consisting of a mobile phone, a personal digital assistant (PDA), a handheld game player, a digital camera, and a Palm computer.

6. The method of claim 4, further comprising:
setting a mark icon for each album, and adding the mark icon of each album to a location on the electronic map according to the average longitude and the average latitude of the camera for images in each album.

7. A storage medium having stored thereon instructions that, when executed by a mobile electronic device, causing the mobile electronic device to perform a method for sorting images in the mobile electronic device, the method comprising:
acquiring a longitude and a latitude of the mobile electronic device determined by a Global Position System (GPS) when an image has been captured by a camera of the mobile electronic device;
associating the image with the longitude and the latitude of the mobile electronic device when capturing the image;
setting a sorting distance for sorting all images captured by the camera of the mobile electronic device, wherein the sorting distance is a distance between a first longitude and a first latitude of the mobile electronic device when capturing a first image and a second longitude and a second latitude of the mobile electronic device when capturing a second image;
sorting all captured images according to the sorting distance, and generating one or more albums containing a group of captured images; and
computing an average longitude and an average latitude of the mobile electronic device for all sorted images in each album, and associating each album with the electronic map according to the average longitude and the average latitude of the mobile electronic device for all images in each album.

8. The medium of claim 7, wherein the mobile electronic device is selected form the group consisting of a mobile phone, a personal digital assistant (PDA), a handheld game player, a digital camera, and a Palm computer.

9. The medium of claim 7, further comprising:
setting a mark icon for each album, and adding the mark icon of each album to a location on the electronic map according to the average longitude and the average latitude of the camera for images in each album.
